(19) United States
(12) Patent Application Publication
(10) Pub. No.: US 2014/0049976 A1
(43) Pub. Date: Feb. 20, 2014

(54) A.S.D. lights system

(71) Applicants: Henry Joseph Leason, Laguna Hills, CA (US); Dewayne Joseph Fisher, (US)

(72) Inventors: Henry Joseph Leason, Laguna Hills, CA (US); Dewayne Joseph Fisher, (US)

(21) Appl. No.: 13/374,690

(22) Filed: Jan. 9, 2012

Related U.S. Application Data
(60) Provisional application No. 61/462,114, filed on Jan. 28, 2011.

(51) Int. Cl. B60Q 1/44; B60Q 1/50

(52) U.S. Cl. CPC B60Q 1/44; B60Q 1/50
USPC 362/541

(57) ABSTRACT

The intent of this present invention referred to as the A.S.D. light system is to prevent rear end collisions and therefore improve safety and reduce fatalities on highways and streets. These tail lights indicate whether the vehicle Is accelerating, stopping or decelerating. The A.S.D. light System places an additional light on each side of a vehicle's existing high center brake light. To the immediate left of the brake light is a green light that indicates acceleration. To the immediate right of the brake light is an amber light that indicates deceleration. Although this invention has been described with respect to Specific embodiments, it is not intended to be limited thereto In it's various modifications which will become apparent to the person of ordinary skill in the art and is intended to fall within the spirit and scope of the inventor as described herein taken in conjunction with the accompanying drawings and the appended claim herein.

### FIELD OF THE INVENTION

The present invention pertains to the field of vehicles, and more specifically to the field of motor vehicle parts and accessories, and even more specifically to the field of indicator lights for use with motor vehicles.

### BACKGROUND OF THE INVENTION

The prior art has put forth several designs for vehicular tail and signal lights. Among these are:

U.S. Pat. No. 7,431,486 to Pascal J. H. Bloemen, Willem H. Smits, Nicola B. Pfeffer and Wiep Folkerts describes a LED assembly for rear lamps in an automobile to function as stop lights, turn signals and tail lights.

U.S. Pat. No. 6,753,769 to Lawrence T. Elliott describes a progressive slow to stop signaling system for tail lights in vehicles comprising a plurality of yellow and red lamps mounted on the rear of a vehicle and signaling impending changes in the speed of the vehicle.

U.S. Pat. No. 4,470,036 to John F. Doerr and Richard L. Miller describes a safety light warning system for vehicles having three modes of operation; namely, stop, caution and go. The caution mode operates when neither gas nor brake pedals are depressed. The stop mode indicates the brake pedal is being depressed and the go mode indicates the accelerator pedal is being depressed.

None of these prior art references describe the present invention.

### SUMMARY OF THE INVENTION

It is an object of the present invention to provide an auxiliary set of tail lights for indicating when the vehicle is accelerating, stopping and decelerating.

### BRIEF DESCRIPTION OF THE DRAWINGS

FIG. 1 is a close up view of an automobile's rear window showing an auxiliary tail light in the top right side of the rear window.

FIG. 2 is a rear view of an automobile showing an auxiliary tail light in the top right side of the rear window.

FIG. 3 is a rear view of a semi-tractor trailer truck showing an auxiliary tail to the light left of the existing brake light above the back door panels.

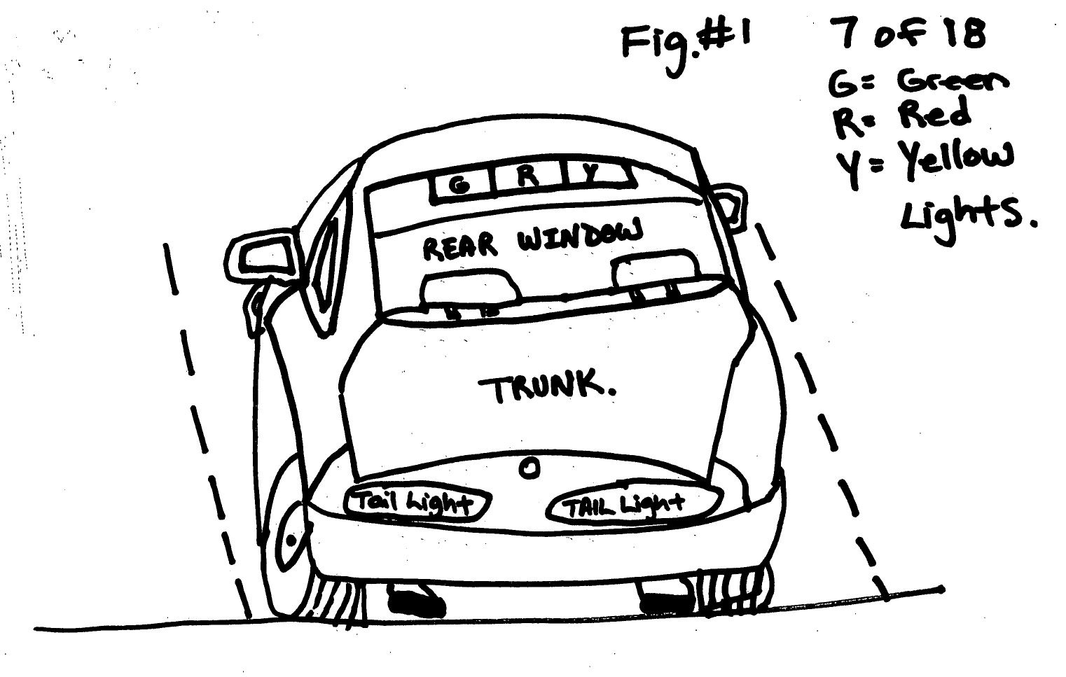

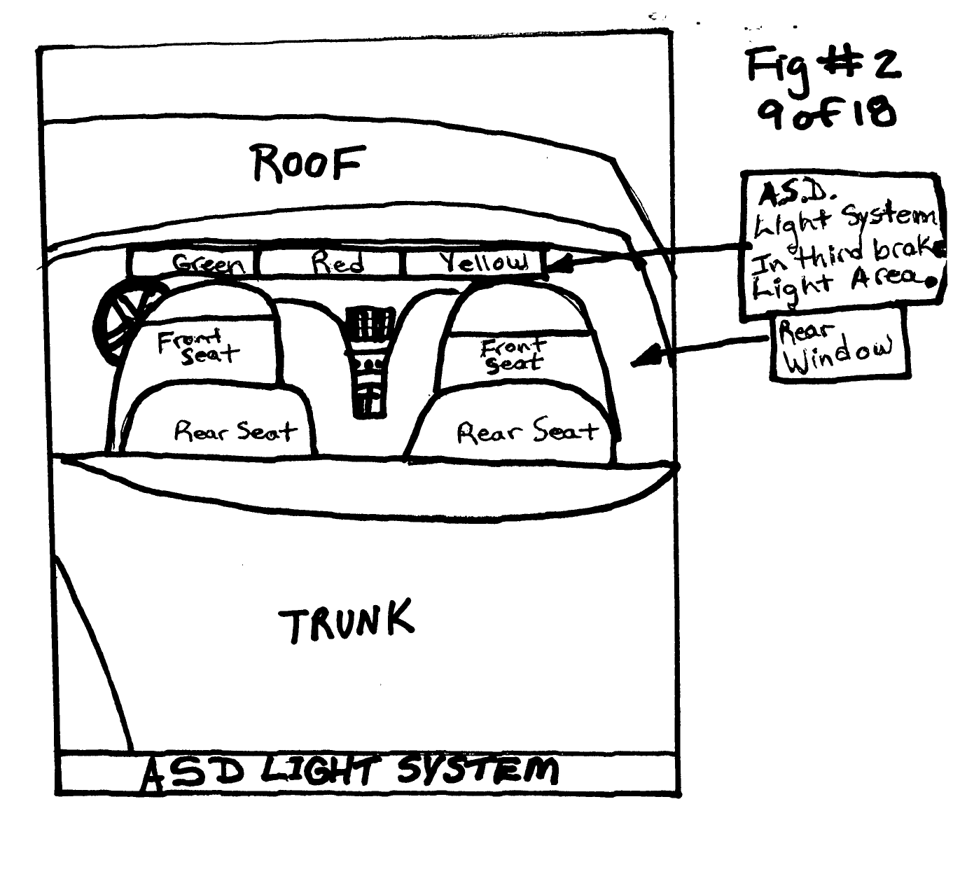

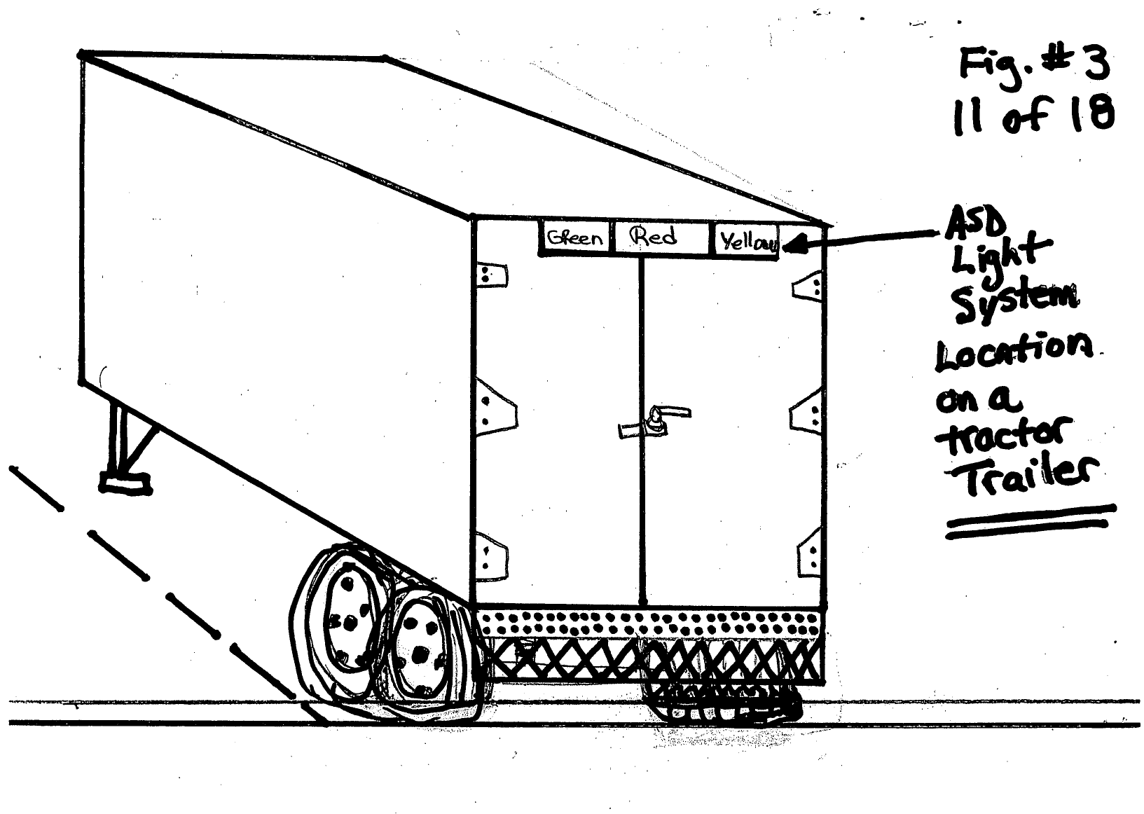

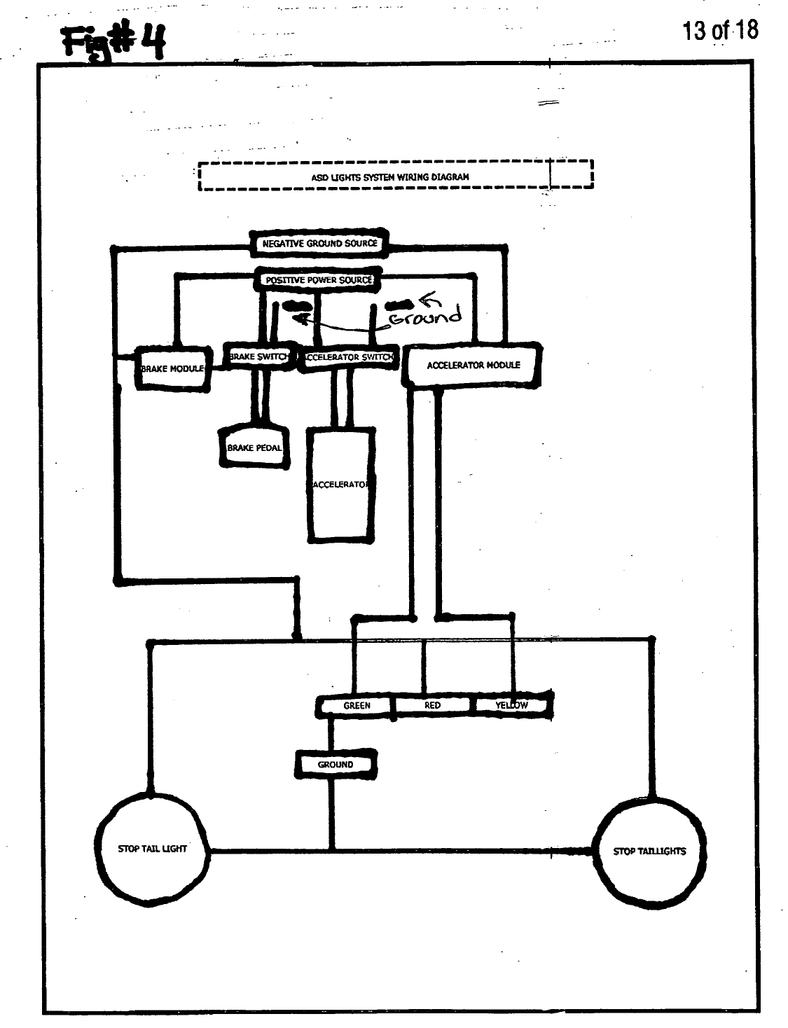

### DETAILED DESCRIPTION OF THE INVENTION

The automobile has been a blessing to families and individuals, and also a lethal danger. One moment of inattention, a few miles per hour too fast, or an instant's lapse in reaction time can be a tragedy. When it comes to accidents, the two most common causes cited are following too closely and travelling too fast for conditions. These accidents can result in tragic and costly injuries and fatalities. Defensive driving is a key to survival. Safety also depends on a vehicle's safety equipment such as brakes and seat belts.

The present invention, hereinafter referred to as the A.S.D. Light System, equips new motor vehicles with an auxiliary set of three tail lights mounted on the interior the rear window. These tail lights indicate whether the vehicle is accelerating, stopping or decelerating. The A.S.D. Lights System places an additional light on each side of a vehicle's existing high center brake light. The following locations of the auxiliary tail lights place the viewer behind the vehicle, facing the vehicle's rear window or rear door panels. To the immediate left of this brake light is a green light that indicates acceleration. To the immediate right of the brake light is an amber light that indicates deceleration, a coasting condition when the driver has released the accelerator, but is not actively braking. The red light indicates braking. These auxiliary lights are wired into the vehicle's acceleration system and function automatically. The A.S.D. Lights System for passenger sedans will be placed at the bottom of the rear window. The A.S.D. Lights System for vans, pickups and SUVs will be placed in the inside top of the rear window. The A.S.D. Lights System equips every new vehicle with three indicator tail lights, each tail light representing a distinct change in that vehicle's velocity. Green indicates the vehicle is accelerating, amber indicates the vehicle is decelerating, and red indicates the vehicle is stopping or braking.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. An auxiliary set of three tail lights which indicate a vehicle's acceleration, stopping and deceleration, essentially as described herein.
